(19) United States
(12) Patent Application Publication
(10) Pub. No.: US 2026/0143485 A1
(43) Pub. Date: May 21, 2026

(54) SINGLE TRANSPORT BLOCK SCHEDULING FOR A USER EQUIPMENT OPERATING IN A MULTI-CARRIER OPERATION

(71) Applicant: QUALCOMM Incorporated, San Diego, CA (US)

(72) Inventors: Kianoush HOSSEINI, San Diego, CA (US); Jing JIANG, San Diego, CA (US)

(21) Appl. No.: 18/949,588

(22) Filed: Nov. 15, 2024

(51) Int. Cl. H04W 72/1263; H04W 8/24; H04W 72/0453

(52) U.S. Cl. CPC H04W 72/1263; H04W 8/24; H04W 72/0453

(57) ABSTRACT

Various aspects of the present disclosure generally relate to wireless communication. In some aspects, a user equipment (UE) may transmit capability information indicating: UE support for single transport block (sTB) scheduling when the UE is operating in a multi-carrier operation, and one or more conditions associated with the sTB scheduling when the UE is operating in the multi-carrier operation. The UE may receive, based at least in part on the capability information, at least one of: configuration information associated with the sTB scheduling when the UE is operating in the multi-carrier operation, or a scheduling communication that schedules an sTB-based transmission when the UE is operating in the multi-carrier operation. Numerous other aspects are described.

### FIELD OF THE DISCLOSURE

Aspects of the present disclosure generally relate to wireless communication and specifically relate to techniques, apparatuses, and methods associated with single transport block scheduling for a user equipment operating in a multi-carrier operation.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include transmitting capability information indicating UE support for single transport block (sTB) scheduling when the UE is operating in a multi-carrier operation and one or more conditions associated with the sTB scheduling when the UE is operating in the multi-carrier operation. The method may include receiving, based at least in part on the capability information, at least one of configuration information associated with the sTB scheduling when the UE is operating in the multi-carrier operation or a scheduling communication that schedules an sTB-based transmission when the UE is operating in the multi-carrier operation.

Some aspects described herein relate to a method of wireless communication performed by a network node. The method may include receiving, from a UE, capability information indicating UE support for sTB scheduling when the UE is operating in a multi-carrier operation and one or more conditions associated with the sTB scheduling when the UE is operating in the multi-carrier operation. For example, the multi-carrier operation may be associated with a carrier aggregation (CA) and/or dual connectivity (DC) multi-carrier operation, in which each component carrier (CC) is treated as an individual cell, each with its own scheduling and control functionalities (e.g., in which a primary cell (PCell) typically handles control signaling, while secondary cells (SCells) are used to enhance data throughput). In some other examples, the multi-carrier operation may be associated with a supplemental uplink (SUL) multi-carrier operation, in which one downlink (DL) CC is paired with two uplink (UL) CCs to form a single cell (e.g., in which the combined use of multiple UL CCs enhances uplink capacity and coverage while coordinating with a single DL CC for streamlined control and data reception). Moreover, in some other examples, the multi-carrier operation may be associated with a virtual cell multi-carrier operation, in which multiple CCs from the same or different frequency bands are aggregated to form a single, unified virtual cell (e.g., enabling coordinated scheduling and resource management across all the aggregated CCs). The method may include transmitting, to the UE and based at least in part on the capability information, at least one of configuration information associated with the sTB scheduling when the UE is operating in the multi-carrier operation or a scheduling communication that schedules an sTB-based transmission when the UE is operating in the multi-carrier operation.

Some aspects described herein relate to a UE for wireless communication. The UE may include one or more memories and one or more processors coupled to the one or more memories. The one or more processors may be configured, individually or in any combination, to transmit capability information indicating UE support for sTB scheduling when the UE is operating in a multi-carrier operation and one or more conditions associated with the sTB scheduling when the UE is operating in the multi-carrier operation. The one or more processors may be configured, individually or in any combination, to receive, based at least in part on the capability information, at least one of configuration information associated with the sTB scheduling when the UE is operating in the multi-carrier operation or a scheduling communication that schedules an sTB-based transmission when the UE is operating in the multi-carrier operation.

Some aspects described herein relate to a network node for wireless communication. The network node may include one or more memories and one or more processors coupled to the one or more memories. The one or more processors may be configured, individually or in any combination, to receive, from a UE, capability information indicating UE support for sTB scheduling when the UE is operating in a multi-carrier operation and one or more conditions associated with the sTB scheduling when the UE is operating in the multi-carrier operation. The one or more processors may be configured, individually or in any combination, to transmit, to the UE and based at least in part on the capability information, at least one of configuration information associated with the sTB scheduling when the UE is operating in the multi-carrier operation or a scheduling communication that schedules an sTB-based transmission when the UE is operating in the multi-carrier operation.

Some aspects described herein relate to a non-transitory computer-readable medium that stores a set of instructions for wireless communication by a UE. The set of instructions, when executed by one or more processors of the UE, may cause the UE to transmit capability information indicating UE support for sTB scheduling when the UE is operating in a multi-carrier operation and one or more conditions associated with the sTB scheduling when the UE is operating in the multi-carrier operation. The set of instructions, when executed by one or more processors of the UE, may cause the UE to receive, based at least in part on the capability information, at least one of configuration information associated with the sTB scheduling when the UE is operating in the multi-carrier operation or a scheduling communication that schedules an sTB-based transmission when the UE is operating in the multi-carrier operation.

Some aspects described herein relate to a non-transitory computer-readable medium that stores a set of instructions for wireless communication by a network node. The set of instructions, when executed by one or more processors of the network node, may cause the network node to receive, from a UE, capability information indicating UE support for sTB scheduling when the UE is operating in a multi-carrier operation and one or more conditions associated with the sTB scheduling when the UE is operating in the multi-carrier operation. The set of instructions, when executed by one or more processors of the network node, may cause the network node to transmit, to the UE and based at least in part on the capability information, at least one of configuration information associated with the sTB scheduling when the UE is operating in the multi-carrier operation, or a scheduling communication that schedules an sTB-based transmission when the UE is operating in the multi-carrier operation.

Some aspects described herein relate to an apparatus for wireless communication. The apparatus may include means for transmitting capability information indicating support for sTB scheduling when the apparatus is operating in a multi-carrier operation and one or more conditions associated with the sTB scheduling when the apparatus is operating in the multi-carrier operation. The apparatus may include means for receiving, based at least in part on the capability information, at least one of configuration information associated with the sTB scheduling when the apparatus is operating in the multi-carrier operation or a scheduling communication that schedules an sTB-based transmission when the apparatus is operating in the multi-carrier operation.

Some aspects described herein relate to an apparatus for wireless communication. The apparatus may include means for receiving, from a UE, capability information indicating UE support for sTB scheduling when the UE is operating in a multi-carrier operation and one or more conditions associated with the sTB scheduling when the UE is operating in the multi-carrier operation. The apparatus may include means for transmitting, to the UE and based at least in part on the capability information, at least one of configuration information associated with the sTB scheduling when the UE is operating in the multi-carrier operation or a scheduling communication that schedules an sTB-based transmission when the UE is operating in the multi-carrier operation.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a

definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A-3C are diagrams illustrating examples of multi-carrier operation, in accordance with the present disclosure.

FIGS. 4A-4C are diagrams of examples associated with single transport block scheduling for a user equipment (UE) operating in a multi-carrier operation, in accordance with the present disclosure.

FIG. 5 is a diagram illustrating an example process performed, for example, at a UE or an apparatus of a UE, in accordance with the present disclosure.

FIG. 6 is a diagram illustrating an example process performed, for example, at a network node or an apparatus of a network node, in accordance with the present disclosure.

FIG. 7 is a diagram of an example apparatus for wireless communication, in accordance with the present disclosure.

FIG. 8 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Mobile communication technologies have evolved, with advancements in carrier aggregation (CA) (sometimes referred to herein as multi-carrier operation) aiming to enhance network efficiency and performance. Multi-carrier operation enables multiple carrier frequencies, or component carriers (CCs), to be combined, enhancing data rates and network capacity. This aggregation creates a wider bandwidth by using a single or multiple bands, which can be intra-band (contiguous or non-contiguous) or inter-band. Multi-carrier operations may be controlled by a single scheduler to manage multiple aggregated carriers as though they were a single carrier, enabling uniform control and optimization.

However, there are challenges associated with multi-carrier operation that impact its efficacy and performance. In theory, multi-carrier operation should enable devices to benefit from the best carrier, in terms of signal quality, and optimize the use of the radio frequency spectrum. Yet, in practice, the realization of these benefits is not guaranteed due to limitations in coordination across carriers. Often, schedulers are modular and lack full integration, leading to underutilization of available spectral resources, inability to perform cross-CC scheduling, and inefficient handling of transmission and re-transmission operations which can hamper the device's performance and power efficiency. Further, specific implementations may still treat each aggregated carrier as separate hybrid automatic repeat request (HARQ) entities, thereby reducing potential gains in diversity and flexibility. Multi-carrier operation may also introduce complexities during initial access procedures, particularly in frequency bands where massive multiple input multiple output (MIMO) gains could otherwise be leveraged if not for the CA constraints.

Additionally, techniques involving scheduling of a transport block (TB) (sometimes referred to herein as “single TB (sTB) scheduling”) across different sub-bands (SBs) or CCs further complicate device processing compared to traditional CA. This sTB scheduling across multiple carriers may require multiple processing operations for a single code block and may also necessitate a user equipment (UE) to process overlapping SBs simultaneously, impacting the UE's data pipelining and processing timelines.

Various aspects relate generally to enhancing multi-carrier operation by introducing more dynamic and flexible capabilities for scheduling transmissions across multiple carriers. Some aspects more specifically relate to a UE transmitting capability information indicating support for sTB scheduling during multi-carrier operation, along with one or more conditions associated with this sTB scheduling. In some aspects, the UE may receive, based on this capability information, either configuration information associated with sTB scheduling or a scheduling communication for sTB-based transmissions.

Particular aspects of the subject matter described in the disclosure can be implemented to realize one or more of the following benefits. In some examples, by enabling a UE to transmit detailed capability information pertaining to conditions and restrictions of sTB scheduling during multi-carrier operation, the described techniques enable more precise configuration and dynamic scheduling of wireless communication resources according to the UE's actual capabilities and operational bandwidth limits. This enables better utilization of the spectrum resources and may help in reducing scheduling inefficiencies that might otherwise arise from non-optimized use of spectrum resources.

A communication system may optimize the utilization of physical layer resources and minimize the impact of signaling overhead by tailoring resource blocks to the actual capabilities of the UE. This may result in improved spectral efficiency, which is particularly beneficial in densely populated network environments where spectrum resources are at a premium. Moreover, by introducing a more tailored approach to sTB scheduling during multi-carrier operation, the UE's processing overhead may be reduced, which may conserve processing resources and battery life, leading to longer UE operational times and reduced energy consumption. In this way, aspects described herein may conserve processing resources, memory resources, network resources, and/or the like.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

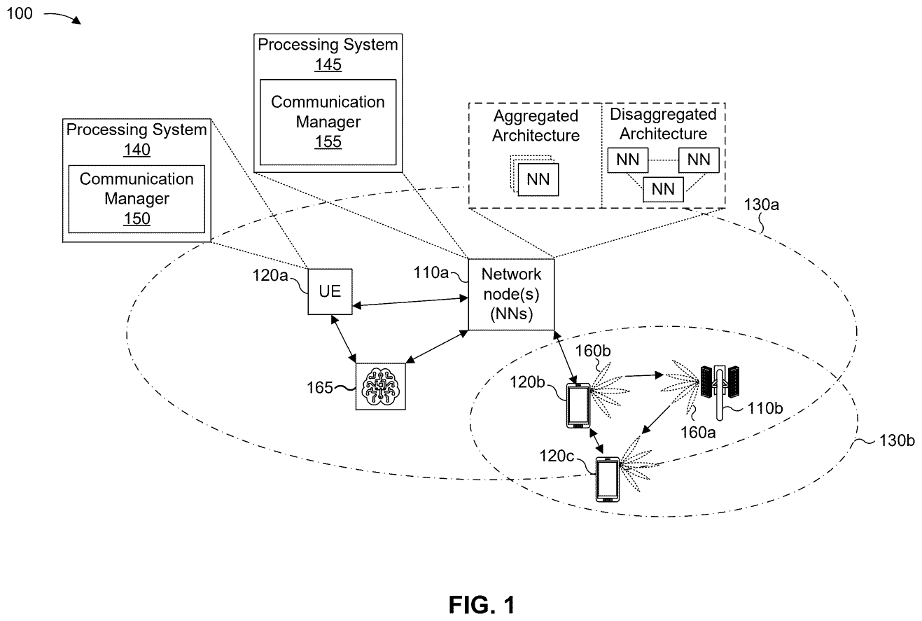

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

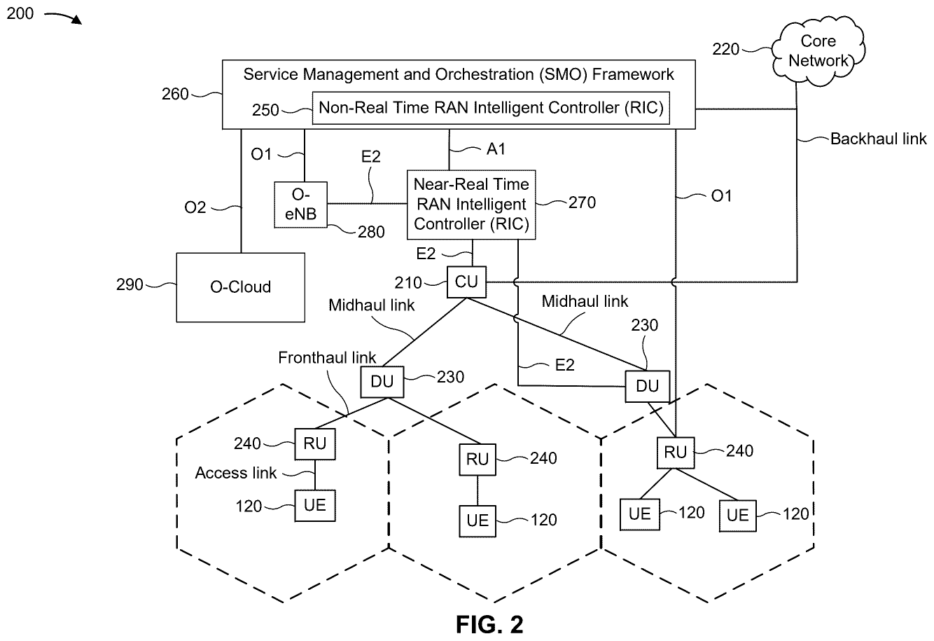

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, CCs, subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As indicated above, a BWP may be configured as a subset or a part of a total or full component carrier bandwidth and generally forms or encompasses a set of contiguous RBs within the full component carrier bandwidth. In other words, within the carrier bandwidth, a BWP starts at a specifically configured RB and may span a specific set of consecutive RBs. Each BWP may be associated with its own numerology (indicating an SCS and CP). A UE 120 may be configured with up to four downlink BWPs and up to four uplink BWPs for each serving cell. To reduce UE power consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

As used herein, a downlink signal may be or include a reference signal, control information, or data. For example, downlink reference signals include a primary synchronization signal (SS) (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may transmit capability information indicating: UE support for sTB scheduling when the UE is operating in a multi-carrier operation, and one or more conditions associated with the sTB scheduling when the UE is operating in the multi-carrier operation; and receive, based at least in part on the capability information, at least one of: configuration information associated with the sTB scheduling when the UE is operating in the multi-carrier operation, or a scheduling communication that schedules an sTB-based transmission when the UE is operating in the multi-carrier operation. Additionally, or alternatively, the communication manager 150 may perform one or more other operations described herein.

In some aspects, the network node 110 may include a communication manager 155. As described in more detail elsewhere herein, the communication manager 155 may receive, from a UE, capability information indicating: UE support for sTB scheduling when the UE is operating in a multi-carrier operation, and one or more conditions associated with the sTB scheduling when the UE is operating in the multi-carrier operation; and transmit, to the UE and based at least in part on the capability information, at least one of: configuration information associated with the sTB scheduling when the UE is operating in the multi-carrier operation, or a scheduling communication that schedules an sTB-based transmission when the UE is operating

in the multi-carrier operation. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

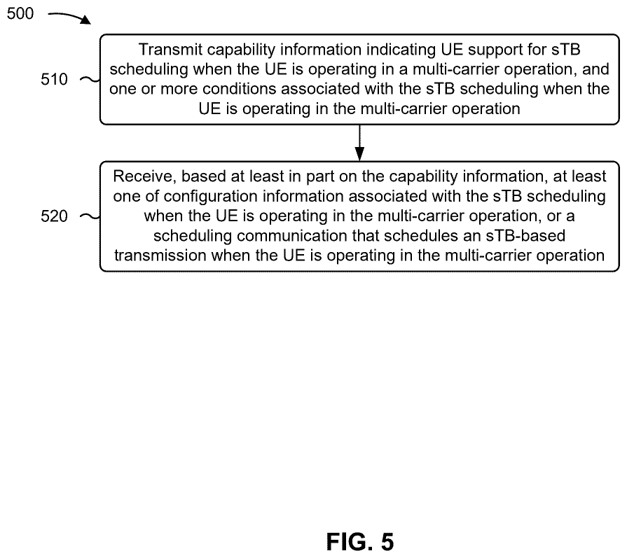

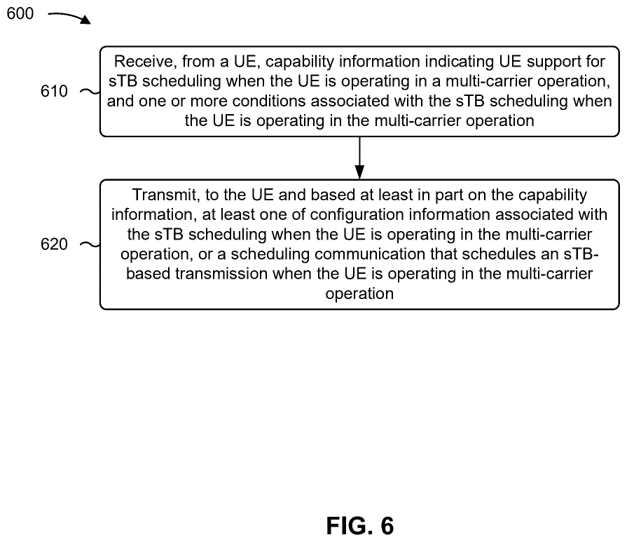

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with sTB scheduling for a UE operating in a multi-carrier operation, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

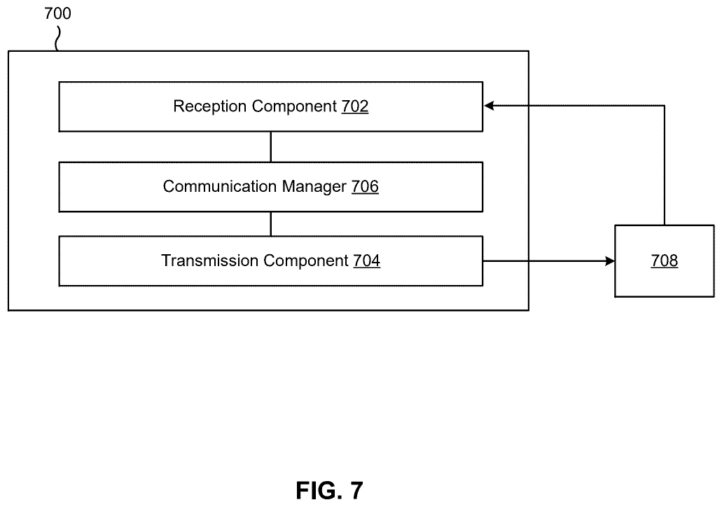

In some aspects, the UE 120 includes means for transmitting capability information indicating: UE support for sTB scheduling when the UE 120 is operating in a multi-carrier operation, and one or more conditions associated with the sTB scheduling when the UE 120 is operating in the multi-carrier operation; and/or means for receiving, based at least in part on the capability information, at least one of: configuration information associated with the sTB scheduling when the UE 120 is operating in the multi-carrier operation, or a scheduling communication that schedules an sTB-based transmission when the UE 120 is operating in the multi-carrier operation. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

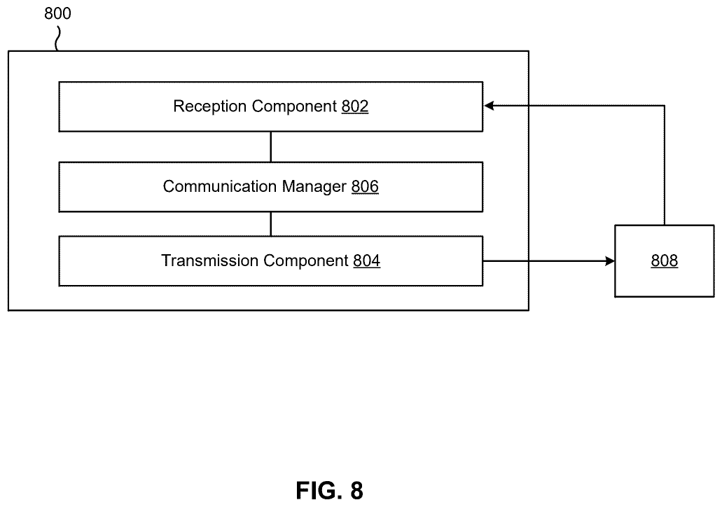

In some aspects, the network node 110 includes means for receiving, from a UE, capability information indicating: UE support for sTB scheduling when the UE is operating in a multi-carrier operation, and one or more conditions associated with the sTB scheduling when the UE is operating in the multi-carrier operation; and/or means for transmitting, to the UE and based at least in part on the capability information, at least one of: configuration information associated with the sTB scheduling when the UE is operating in the multi-carrier operation, or a scheduling communication that schedules an sTB-based transmission when the UE is operating in the multi-carrier operation. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

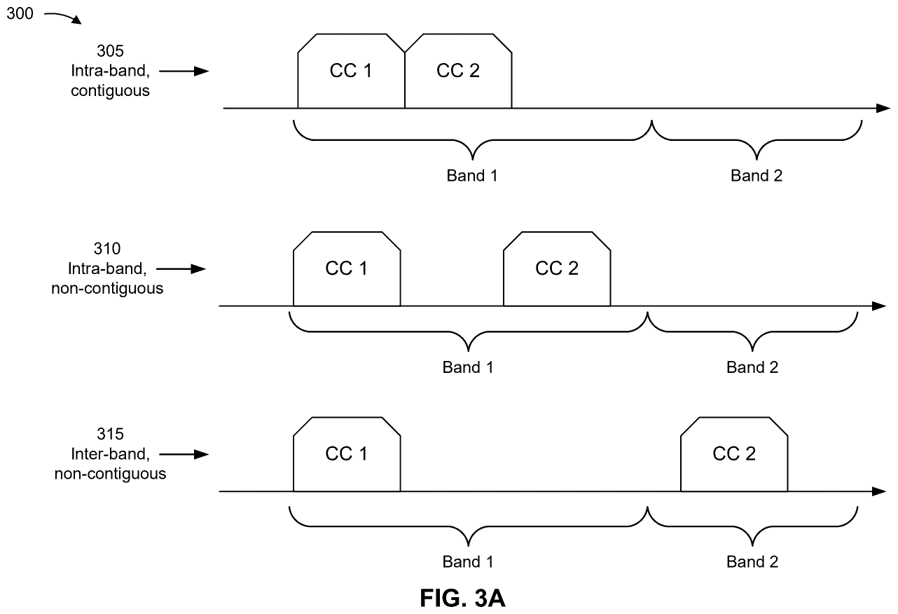

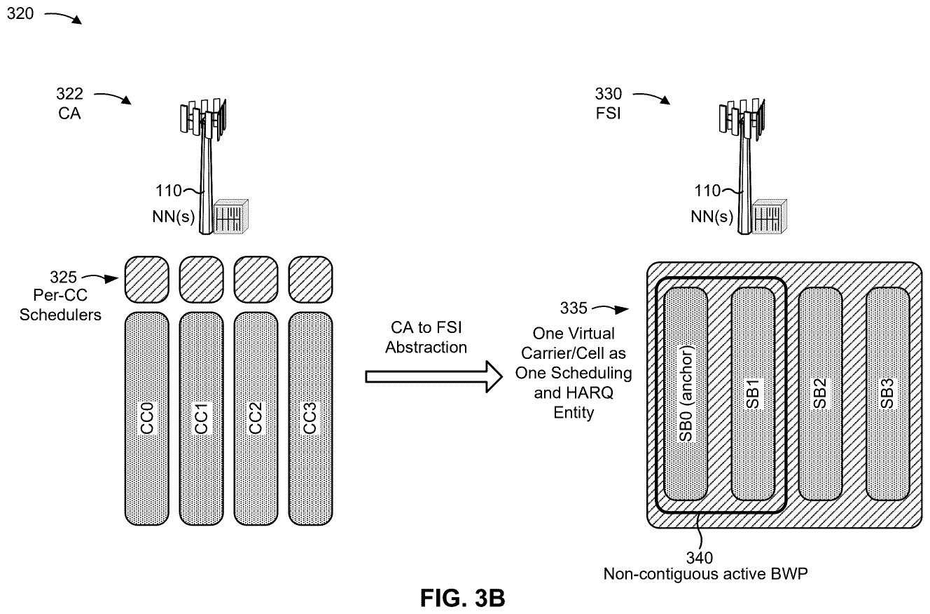

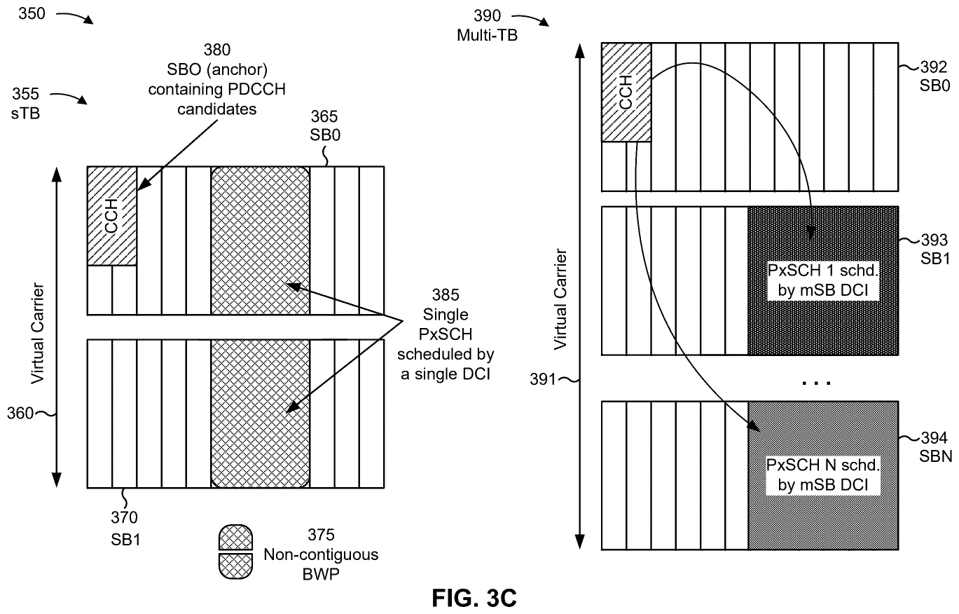

FIGS. 3A-3C are diagrams illustrating examples of multi-carrier operation, in accordance with the present disclosure.

FIG. 3A is a diagram illustrating examples 300 of CA. CA is a technology that enables two or more CCs (sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, DCI, and/or another signaling message.

As shown by reference number 305, in some aspects, CA may be configured in an intra-band contiguous mode where the aggregated carriers are contiguous to one another and are in the same band. As shown by reference number 310, in some aspects, CA may be configured in an intra-band non-contiguous mode where the aggregated carriers are non-contiguous to one another and are in the same band. As shown by reference number 315, in some aspects, CA may be configured in an inter-band non-contiguous mode where the aggregated carriers are non-contiguous to one another and are in different bands.

In CA, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

In some examples, CA may enable leveraging the best CCs to carry DL and/or UL data. Moreover, CA may enable extending DL coverage by carrying UL control information on the most robust cell (e.g., the Pcell). Additionally, or alternatively, CA may enable cross-CC scheduling, may improve PDCCH and/or other control channel (CCH) signaling reliability, and/or may improve power savings at the UE 120. However, CA may be inefficient in aggregating small, scattered, and/or low-band CCs. This is because CA may be associated with per-CC independent scheduling and/or may require separate HARQ entities for each CC such that transmission and retransmission must be performed in the same CC, resulting in a lack of diversity. Additionally, or alternatively, Pcell and/or Scell abstraction associated with CA may reduce flexibility.

Moreover, although, in theory, all CCs in CA may be controlled by a single MAC entity (e.g., a single scheduler), in practice CA may not operate with a truly single and fully coordinated scheduler. This is because, in practice, a scheduler for CA may remain modular and thus not fully integrated. For example, in some deployments, only a HARQ operation is coordinated across CCs. Accordingly, many benefits of CA may not be realized in the field. For example, CA may not result in the best CC being used for DL and/or UL data and/or control information, and/or CA may not result in performing cross-CC scheduling. In this way, power saving benefits at the UE 120 that may arise from CA in theory may not actually be realized in the field.

In some examples, certain multi-carrier operations may be associated with aggregating frequency resources in a more integrated fashion than in CA, such as for a purpose of realizing CA theoretical benefits without the associated drawbacks. For example, FIG. 3B shows an example 320 of flexible spectrum integration (FSI), as another example of a multi-carrier operation. More particularly, as indicated by reference number 322, in CA each CC (shown in this example as a first CC (indexed as CC0) through a fourth CC (indexed as CC3)) may be associated with a separate scheduler, as described above in connection with FIG. 3A. Put another way, as indicated by reference number 325 and as shown by using four rounded boxes with hatching, one for each CC, CA may be associated with per-CC schedulers.

On the other hand, as shown by reference numbers 330 and 335, in FSI one virtual carrier and/or cell may serve as a scheduling and HARQ entity for multiple SBs, shown in FIG. 3B as a first SB (indexed as SB0, which may serve as an anchor SB) through a fourth SB (indexed as SB3). In such examples, an SB may correspond to one physical carrier (e.g., a CC) or a portion of a physical carrier (e.g., a portion of a CC). Moreover, because the one virtual carrier and/or cell is a single cell, the single cell may be controlled by a truly single scheduler. In some examples, numerology alignment across frequency and/or time domains between the SBs may facilitate integration of resources across the SBs. Additionally, or alternatively, in some examples an active BWP may extend across multiple SBs. For example, in FIG. 3B a non-contiguous active BWP comprises SB0 and SB1, as indicated by reference number 340.

In such examples, the multiple SBs may be viewed as a single cell from the scheduling and/or HARQ point of view. Accordingly, the network may employ a monolithic scheduler developed from a specific channel bandwidth for a virtual carrier of the same bandwidth. This may enable fully coordinated DL and/or UL scheduling, such as by enabling multiple SB scheduling (sometimes referred to herein as x-SB scheduling) with a single CC worth of control channel elements (CCEs) and/or PDCCH blind decodings (BDs). Additionally, or alternatively, FSI may enable a reduced memory requirement for keeping configurations, particularly in intra-band scenarios. Moreover, FSI may enable performance of bandwidth adaptation (e.g., including baseband (BB) and/or RF adaptation) by switching a BWP. Moreover, FSI may enable a better and/or more efficient initial access procedures.

FIG. 3C shows examples 350 associated with TB scheduling in a multi-carrier operation, such as in FSI. First, as indicated by reference number 355, in sTB scheduling for a multi-carrier operation, a virtual carrier 360 (e.g., a virtual cell) may be associated with multiple SBs, such as a first SB 365 (indexed as SB0 in FIG. 3C) and a second SB 370 (indexed as SB1 in FIG. 3C). Moreover, a scheduler may be capable of scheduling an sTB across the multiple SBs 365, 370, such as by scheduling an sTB using a non-contiguous BWP 375 that encompasses the multiple SBs 365, 370 or frequency resources assigned to different CCs or cells. More particularly, as indicated by reference number 380, the first SB 365 (e.g., SB0) may serve as anchor SB that contains a CCH (e.g., PDCCH candidates). In this way, a UE 120 may perform single-CC PDCCH BD on the anchor SB. A scheduler may transmit a single DCI (e.g., in the CCH) that schedules a single PUSCH or PDSCH (collectively referred to herein as PxSCH for ease of description) that spans the multiple SBs 365, 370, as indicated by reference number 385. Put another way, each TB may be mapped onto the non-contiguous BWP 375 activated within the virtual cell. The sTB may be mapped across the SBs 365, 370 with a code block (CB)-level interleaving process, which may be favorable in low-band spectrum with small channels. In some aspects, an sTB spanning the different SBs 365, 370 may be scheduled with different link parameters, such as modulation order and/or rank. Put another way, although coding rate may be unique for one TB, modulation orders and ranks may be set differently across different SBs 365, 370.

In some examples, sTB scheduling across the multiple SBs 365, 370 may be performed in one of two ways. In a first option, a TB size may be determined by the aggregated set of scheduled resources across the multiple SBs 365, 370, in a similar manner as shown in connection with reference number 355. In such examples, a single redundancy version (RV) index may be used to read encoded bits from a circular buffer. In another option (not shown), a TB size may be determined based on resources in one SB. In such examples, a same TB may be repeated multiple times (potentially with different RV indexes) across the SBs 365, 370.

On the other hand, as indicated by reference number 390, in multi-TB scheduling, a virtual carrier 391 may be associated with multiple SBs, such as a first SB 392 (indexed as SB0 in FIG. 3C), a second SB 393 (indexed as SB1 in FIG. 3C), and so forth through an N^{th} SB 394 (indexed as SBN in FIG. 3C). Moreover, a scheduler may be capable of scheduling multiple TBs across the multiple SBs 392-394 using a single DCI, sometimes referred to as a multi-SB (mSB) scheduling DCI, or simply an mSB DCI. In such examples, a lower-band SB (e.g., the first SB 392 (e.g., SB0) in the example shown in FIG. 3C) may be used as an anchor SB, and higher band SBs (e.g., the second SB 393 (e.g., SB1) through the N^{th} SB 394 (e.g., SBN) in the example shown in FIG. 3C) may be used to carry TBs (e.g., PxSCH communications). In such examples, each TB may be mapped onto a single SB of the virtual cell. A UE may perform a single-CC PDCCH BD that schedules multiple TBs on different SBs. For example, an mSB DCI may schedule PxSCH 1 on the first SB 392 and may schedule PxSCH N on the N^{th} SB 394, among other examples. In some examples, multi-TB scheduling may be used for scheduling with large aggregated channel bandwidths, where cross-SB diversity is not needed. Additionally, or alternatively, in some examples both intra-band and inter-band scenarios may be supported by multi-TB scheduling. Moreover, because the virtual carrier 391 may be associated with a single HARQ entity, frequency diversity across HARQ transmissions may be achieved.

In some examples, sTB scheduling may have a greater impact to UE pipelining (e.g., the process of managing and coordinating the execution of multiple tasks and/or processes in parallel at the UE) as compared to multi-TB scheduling. This is because each CB's bits may be distributed over multiple SBs (e.g., effectively over different CCs in CA). In this regard, certain operations may be launched multiple times per CB. For example, if a modulation order and/or rank of one TB is different across different SBs, de-mapping (e.g., channel estimation and/or computation) may need to be run multiple times per CB. Accordingly, a UE operating in a multi-carrier operation (e.g., one of CA and/or FSI, among other examples) may need to process data over multiple SBs and/or CCs all at once without being able to pipeline PDCCH decoding and/or data channel processing. An impact to UE pipelining may be even more pronounced for examples in which the numerology differs between SBs forming a virtual carrier.

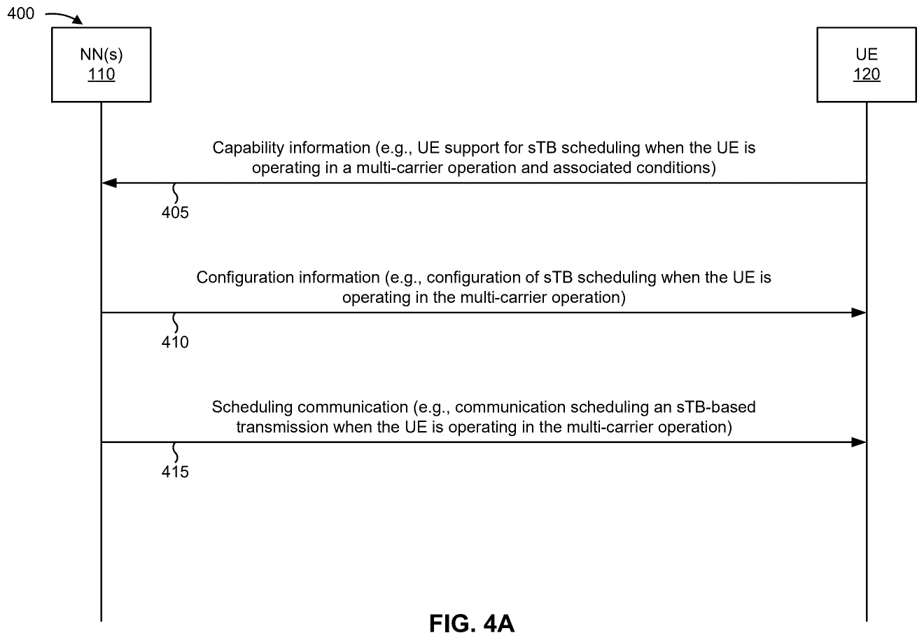

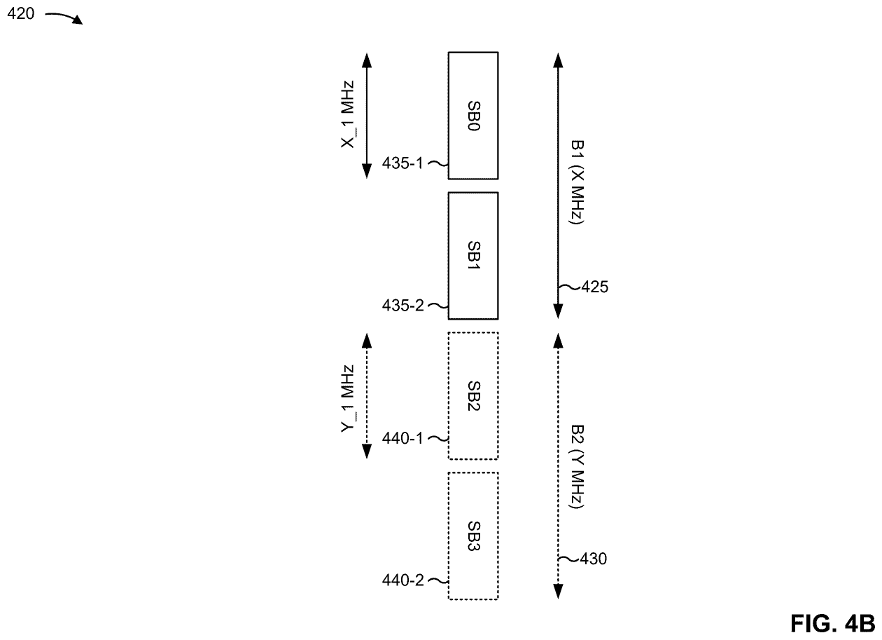

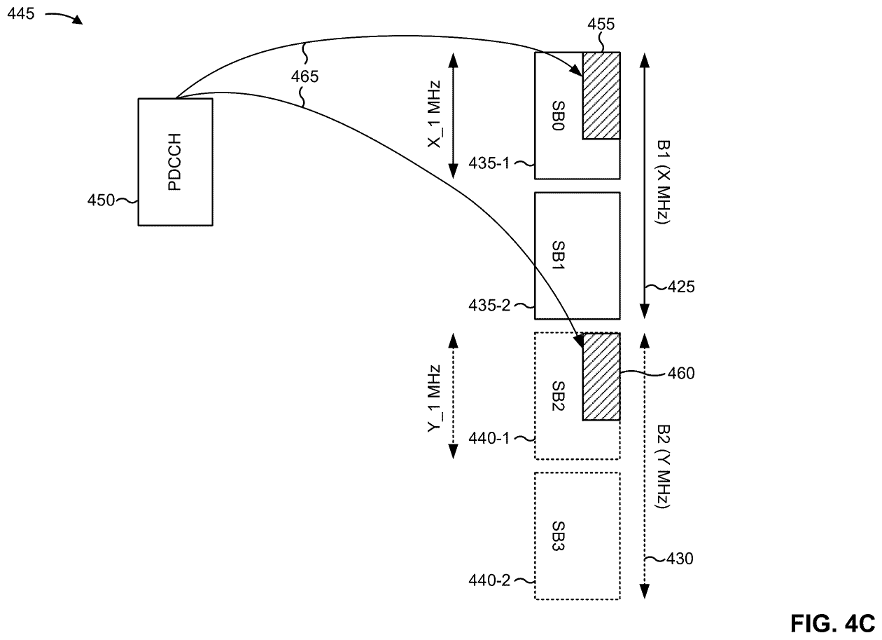

According to some aspects described herein, a UE may signal, to a network node, capabilities and/or restrictions associated with sTB scheduling when the UE is operating in a multi-carrier operation, such that the UE may be scheduled with an sTB across multiple SBs and/or CCs without detrimentally affecting UE pipelining. Put another way, aspects described herein may enable sTB scheduling in cases below the UE's pipelining envelope such that the UE has sufficient processing power to compensate for any extra delays that may occur due to the additional processing that the UE may need to do in DL and/or UL paths for sTB-based transmissions. This may be more readily understood with reference to FIGS. 4A-4C.

As indicated above, FIGS. 3A-3C are provided as examples. Other examples may differ from what is described with regard to FIGS. 3A-3C.

FIGS. 4A-4C are diagrams of examples associated with sTB scheduling for a UE operating in a multi-carrier operation, in accordance with the present disclosure. FIG. 4A shows an example 400 in which a network node 110 (e.g., a CU, a DU, and/or an RU) may communicate with a UE 120. In some aspects, the network node 110 and the UE 120 may be part of a wireless network (e.g., wireless communication network 100). The UE 120 and the network node 110 may have established a wireless connection prior to operations shown in FIG. 4A. In some aspects, the UE 120 may be operating in a multi-carrier operation, such as one of CA (as described above in connection with FIG. 3A) or FSI (as described above in connection with FIG. 3B), among other examples. For example, the multi-carrier operation may be associated with a CA or dual connectivity (DC) multi-carrier operation, in which each CC is treated as an individual cell, each with its own scheduling and control functionalities (e.g., in which a PCell typically handles control signaling, while SCells are used to enhance data throughput). In some other examples, the multi-carrier operation may be associated with a supplemental uplink (SUL) multi-carrier operation, in which one DL CC is paired with two UL CCs to form a single cell (e.g., in which the combined use of multiple UL CCs enhances uplink capacity and coverage while coordinating with a single DL CC for streamlined control and data reception). Moreover, in some other examples, the multi-carrier operation may be associated with a virtual cell multi-carrier operation, in which multiple CCs from the same or different frequency bands are aggregated to form a single, unified virtual cell (e.g., enabling coordinated scheduling and resource management across all the aggregated CCs).

As shown in FIG. 4A, and as indicated by reference number 405, the UE 120 may transmit, and the network node 110 may receive, capability information (e.g., a capabilities report). The capability information may indicate whether the UE 120 supports a feature and/or one or more parameters related to the feature. For example, the capability information may indicate a capability and/or parameter for the UE 120 operating in a multi-carrier operation (e.g., CA, FSI, and/or a similar multi-carrier operation). As another example, the capability information may indicate a capability and/or parameter for sTB scheduling when the UE 120 is operating in the multi-carrier operation. One or more operations described herein may be based on the capability information. For example, the UE 120 may perform a communication in accordance with the capability information, or may receive configuration information that is in accordance with the capability information.

In some aspects, the capability information may indicate UE 120 support for sTB scheduling when the UE 120 is operating in a multi-carrier operation. Additionally, or alternatively, the capability information may indicate one or more conditions associated with the sTB scheduling when the UE 120 is operating in the multi-carrier operation. For example, the one or more conditions may indicate one or more frequency bands and/or frequency band combinations in which the UE 120 supports sTB scheduling, one or more duplex modes in which the UE 120 supports sTB scheduling, maximum bandwidth capacities for which the UE 120 supports sTB scheduling, and/or similar conditions. For example, the capability information may indicate that the UE 120 supports sTB scheduling in certain frequency bands (e.g., 700 MHz, 2.5 GHz, and/or other frequency bands) and specific duplex modes (e.g., frequency division duplex (FDD) bands, time division duplex (TDD) bands, and/or combinations of FDD bands and TDD bands, among other examples). Additionally, or alternatively, the capability information may indicate particular bandwidth combinations the UE 120 can handle, such as a maximum bandwidth of 20 MHz per carrier or aggregated bandwidths up to 100 MHz, among other examples. Additionally, or alternatively, the capability information may indicate a maximum bandwidth difference (sometimes referred to herein as a bandwidth-difference threshold) between respective bandwidths associated with each carrier of the multi-carrier operation. For example, when a difference between a first bandwidth associated with a first carrier of the multi-carrier operation and a second bandwidth associated with a second carrier of the multi-carrier operation is less than a bandwidth-difference threshold, the UE 120 may support sTB scheduling, and/or when the difference between the first bandwidth and the second bandwidth is greater than the bandwidth-difference threshold, the UE 120 may not support sTB scheduling.

In some aspects, the capability information may be signaled integral with other capability information used to indicate UE 120 support for the multi-carrier operation. Put another way, in some aspects UE 120 support of sTB scheduling may be dependent on the support of multi-carrier operation (e.g., CA and/or FSI, among other examples), meaning that the UE 120 may signal support of sTB scheduling under the same or similar reported restrictions as reported by the UE 120 for supporting the multi-carrier operation. For example, the UE 120 may indicate support for sTB scheduling on at least one of a feature set per component carrier (FSPC) basis, a feature set basis, a frequency band basis, and/or a similar basis.

For example, for the support of multi-carrier operation, the UE 120 may report supported band combinations, supported bandwidth classes, and/or bandwidth combination sets, such as by using a SupportedBandCombinationSet Feature Group (FG). The SupportedBandCombinationSet FG may enable the UE 120 to communicate its ability to aggregate multiple CCs and/or SBs across various frequency bands, bandwidth classes, and duplex modes. Each combination set may specify the maximum number of aggregated carriers, their individual bandwidth classes, and applicable duplex modes. In some aspects, when a UE reports its multi-carrier operation capabilities (e.g., its CA capabilities), the SupportedBandCombinationSet FG encapsulates details such as the list of supported bands, the number of CCs, and the maximum DL and UL bandwidth for each carrier within those combinations.

In some other aspects, the UE 120 may report its multi-carrier operation using a FeatureSetCombination information element (IE). The FeatureSetCombination IE may provide a detailed description of the combinations of features that the UE 120 can support simultaneously within a given multi-carrier operation configuration (e.g., a given CA configuration and/or FSI configuration). In some aspects, the FeatureSetCombination IE may include specifics about modulation schemes, maximum bandwidth, MIMO layers, duplex modes (e.g., FDD/TDD), and other advanced features. For each band combination, the IE may detail the quantity of CCs that can be aggregated and the maximum bandwidth for both DL and UL transmissions. In some aspects, the FeatureSetCombination IE may include multiple rows, with each row including one set of capabilities, across bands in a band combination, that the UE 120 supports. In such aspects, using the FeatureSetCombination IE, the UE 120 may be capable of reporting different sets of capabilities for the same band combination.

In such aspects (e.g., in aspects in which the capability information for sTB scheduling is signaled integral with other capability information used to indicate UE 120 support for the multi-carrier operation), the support for the sTB scheduling may be reported under the same restrictions that the UE 120 provides for the support of the multi-carrier operation. More particularly, UE 120 support for sTB scheduling may be signaled as supported or not supported (e.g., sTB scheduling support may be signaled as either “yes” or “no”) in the same band combination, with the same bandwidth combination and bandwidth combination sets and all other feature sets that are reported for each band or CC in the band combination. For example, in aspects in which the UE 120 signals its support of multi-carrier operation using at least one of the SupportedBandCombinationSet FG or the FeatureSetCombination IE, the UE 120 may further signal support of sTB scheduling for the various combinations and/or parameters reported in the SupportedBandCombinationSet FG and/or the FeatureSetCombination IE. In such aspects, if a UE 120 reports “yes” (e.g., sTB scheduling is supported) for a given quantity of bands, the UE 120 supports sTB scheduling within and across those bands.

For example, the support of sTB scheduling may be reported as a feature set (sometimes referred to herein as a FeatureSet) capability in a FeatureSetCombination IE used to report UE 120 capability with respect to a band combination (BC) that includes two bands, band 1 (B1 ) and band 2 (B2). In such an example, the UE 120 may indicate, using a FeatureSet, whether the UE 120 supports sTB scheduling for each band in the BC. For example, if the UE 120 reports “yes” for B1 and “no” for B2, sTB scheduling may only be supported across CCs and/or SBs that are within B1. Similarly, if the UE 120 reports “no” for B1 and “yes” for B2, sTB scheduling may only be supported across CCs and/or SBs that are within B2. If the UE 120 reports “yes” for B1 and “yes” for B2, sTB scheduling may be supported across CCs and/or SBs within B1, across CCs and/or SBs within B2, and across CCs and/or SBs that are within both bands. Alternatively, the sTB scheduling capability may be reported on a per group of bands (e.g., a pair of bands) per band combination.

In some other aspects, the UE 120 may signal the sTB scheduling capability information separate from other capability information used to indicate UE 120 support for the multi-carrier operation. For example, the UE 120 may signal the sTB scheduling capability information separate from the SupportedBandCombinationSet FG and/or the FeatureSetCombination IE. In such aspects, the UE 120 may signal support of sTB scheduling per UE, per band, per BC, per bandwidth of BC (BoBC), per DL FeatureSet or per UL FeatureSet, and/or per FSPC, among other examples. Additionally, or alternatively, the UE 120 may indicate a total bandwidth supported for sTB scheduling (e.g., the UE 120 may indicate the total bandwidth of the CCs and/or SBs on which sTB is supported). Moreover, the UE 120 may indicate a maximum bandwidth per CC and/or SB supported for sTB scheduling, a maximum bandwidth per CC and/or SB per band supported for sTB scheduling, a maximum bandwidth per band in a BC supported for sTB scheduling, a maximum difference between bandwidths associated with respective carriers of the multi-carrier operation supported for sTB scheduling (e.g., the difference in bandwidth of the frequence resources on which sTB scheduling is to be supported), among other examples. Additionally, or alternatively, the UE 120 may indicate a maximum quantity of CCs and/or SBs supported for sTB scheduling, which may be indicated per band, across bands, or both per band and across bands. Moreover, the UE 120 may indicate a maximum quantity of layers supported for sTB scheduling, which may be indicated per CC and/or SB, across CCs and/or SBs, or both per CC and/or SB and across CCs and/or SBs. For example, sTB scheduling may be supported over multiple (e.g., two) CCs and/or SBs, with each CC and/or SB being associated with a different quantity of layers. Accordingly, the capability information may be indicated on a per CC and/or SB basis, a total quantity of layers basis, or both a per CC and/or SB basis and a total quantity of layers basis.

Additionally, or alternatively, the UE 120 may indicate a maximum MCS and/or modulation order supported for sTB scheduling. Moreover, the UE 120 may indicate a minimum DL processing timeline supported for the sTB scheduling and/or a minimum UL processing timeline supported for the sTB scheduling. Additionally, or alternatively, the UE 120 may indicate a minimum CSI processing timeline supported for the sTB scheduling, a maximum quantity of CSI processes supported for the sTB scheduling, a maximum quantity of TBs per slot supported for the sTB scheduling, a maximum quantity of control channels (e.g., PUCCHs) per slot supported for the sTB scheduling, and/or a maximum quantity of CCEs and/or BDs for control channel monitoring supported for the sTB scheduling.

In some aspects, one or more of the above-described capabilities may be reported by the UE 120 separately for DL and UL (e.g., once for DL and once for UL) or jointly for DL and UL (e.g., the above-described capabilities may be reported once, with the capabilities being applicable to both sTB scheduling of UL communications and sTB scheduling of DL communications). Additionally, or alternatively, in some aspects, by reporting one or more of the above-described capabilities, the UE 120 may may effectively indicate support of the sTB scheduling on a CC and/or SB group within the band combination. For example, the UE 120 may indicate a quantity of CCs and/or SBs supported for sTB scheduling and an associated bandwidth for the quantity of CCs and/or SBs supported for sTB scheduling.

In some aspects, such as aspects in which the UE 120 signals support of sTB scheduling on a per BC basis, the UE 120 may indicate that sTB scheduling is supported in the reported BC only if multi-carrier operation (e.g., CA and/or FSI, among other examples) is configured in the same BC. In some other aspects, such as aspects in which the UE 120 signals support of sTB scheduling on a per BC basis, the UE 120 may indicate that sTB scheduling is supported in the reported BC and any superset BC. For example, if the UE 120 indicates support of sTB scheduling in two bands (e.g., B1 and B2), and if the UE 120 is configured with multi-carrier operation in three bands (e.g., B1 and B2 as well as a third band (B3)), the UE 120 may support sTB scheduling in B1 and B2 of the triple BC.

In some other aspects, instead of or in addition to the UE 120 signaling the above-described capability information, UE 120 support for sTB scheduling when the UE 120 is operating in a multi-carrier operation may be restricted and/or specified by a relevant wireless communication standard, such as a wireless communication standard promulgated by the 3GPP. For example, the wireless communication standard may restrict sTB scheduling to certain bands and/or band combinations (e.g., one or more of TDD+TDD, FDD+FDD, and/or TDD+FDD). Additionally, or alternatively, the wireless communication standard may restrict sTB scheduling to certain duplexing modes (e.g., one or more of half-duplex, full-duplex, SBFD, and/or similar duplexing modes) and/or certain FRs (e.g., one or more of FR1, FR2, FR4a, FR4-1, FR4, FR5, and/or similar FRs). Additionally, or alternatively, the wireless communication standard may restrict sTB scheduling to certain communication directions, such as permitting sTB scheduling only for UL communications, only for DL communications, and/or for both UL and DL communications, among other examples. Additionally, or alternatively, the wireless communication standard may restrict sTB scheduling to situations in which a bandwidth difference between respective bandwidths associated with each carrier of the multi-carrier operation is less than a bandwidth-difference threshold. For example, when a difference between a first bandwidth associated with a first carrier of the multi-carrier operation and a second bandwidth associated with a second carrier of the multi-carrier operation is less than a bandwidth-difference threshold, the wireless communication standard may permit sTB scheduling, and/or when the difference between the first bandwidth and the second bandwidth is greater than the bandwidth-difference threshold, the wireless communication standard may not permit sTB scheduling. For example, a relevant wireless communication standard may allow sTB scheduling for UE 120 operating in a multi-carrier operation only when the sTB is scheduled across FDD bands (e.g., the TB may only be mapped across FDD channels), only when the sTB is scheduled in certain FRs and/or a specified portion of a given FR (e.g., sTB scheduling may be permitted in FDD low bands (e.g., below 1 GHz) but not in FDD mid-bands), and/or only when a difference between respective bandwidths associated with each carrier of the multi-carrier operation is less than a bandwidth-difference threshold, among other examples. In some aspects, restrictions specified by a wireless communication standard may be specified in the form of the channel bandwidth, the total bandwidth, the difference between the bandwidths of different frequency resources and/or CCs to be smaller than a predetermined value (e.g., a bandwidth-difference threshold), among other examples.

In some aspects, based at least in part on the capability information described above and/or any restrictions set by an applicable wireless communication standard, the UE 120 may be semi-statically configured to communicate using sTB scheduling. In that regard, and as indicated by reference number 410, in some aspects, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein, such as the scheduling communication described below in connection with reference number 415) may include a dynamic indication, such as one or more MAC-CEs and/or one or more DCI messages, among other examples.

In some aspects, the configuration information may indicate that the UE is to operate in a multi-carrier operation and/or perform communications associated with sTB scheduling within the multi-carrier environment. For example, the configuration information may indicate that the UE 120 is to perform communications associated with sTB scheduling based on the capability information previously transmitted by the UE 120 (e.g., the capability information described above in connection with reference number 405). Put another way, in some aspects, the configuration information may align with the indicated capabilities and conditions of the capability information, ensuring that sTB scheduling is tailored to the UE 120's operational parameters. For example, the configuration information may include specifics on how sTB scheduling will be implemented, such as the quantity of carriers to be aggregated, the scheduling intervals, or the modulation schemes to be used. In some aspects, the configuration information may indicate dynamic adjustments based on real-time network conditions, such as varying the carrier combinations or bandwidths according to the current network load and the UE 120's real-time capabilities.

The UE 120 may configure itself based at least in part on the configuration information. In some aspects, the UE 120 may be configured to perform one or more operations described herein based at least in part on the configuration information.

In some aspects, the configuration information described in connection with reference number 410 and/or the capability information described in connection with reference number 405 may include information transmitted via multiple communications. Additionally, or alternatively, the network node 110 may transmit the configuration information, or a communication including at least a portion of the configuration information, before and/or after the UE 120 transmits the capability information. For example, the network node 110 may transmit a first portion of the configuration information before the capability information, the UE 120 may transmit at least a portion of the capability information, and the network node 110 may transmit a second portion of the configuration information after receiving the capability information. Additional aspects of the network node 110 semi-statically configuring the UE 120 to communicate using sTB scheduling are described in more detail below in connection with FIG. 4B.

In some other aspects, based at least in part on the capability information described above and/or any restrictions set by an applicable wireless communication standard, the UE 120 may be dynamically scheduled to communicate using sTB scheduling. More particularly, as indicated by reference number 415, the network node 110 may transmit, and the UE 120 may receive, a scheduling communication. In some aspects, the scheduling communication may schedule an sTB-based transmission for the UE 120 when the UE 120 is functioning within the multi-carrier setup. In some aspects, the scheduling communication may be based at least in part on the capability information to dynamically allocate and optimize the use of available wireless communication resources. In some aspects, the scheduling communication may schedule an sTB-based transmission based on the UE 120's constraints and capabilities, including supported frequency bands, duplex modes, maximum bandwidth capacities, and/or similar information indicated in the capability information. For example, if the UE 120 supports higher modulation schemes (e.g., 256-QAM) under certain conditions, the scheduling communication may optimize data rates accordingly. Alternatively, the scheduling communication may prioritize certain carriers over others to maximize coverage or reduce interference in specific scenarios. Additional aspects of the scheduling communication are described in more detail below in connection with FIG. 4C.

The communication process described above in connection with FIG. 4A may improve spectrum utilization and reduce inefficiencies that might otherwise arise from non-optimized use of spectrum resources. By transmitting detailed capability information, the UE 120 enables precise configuration and/or scheduling of sTB-based transmissions, which may minimize the impact of signaling overhead, optimize physical layer resources, and/or conserve the UE 120's processing resources and battery life. For example, by knowing the exact processing limits, the network node 110 may avoid overloading the UE 120, thus extending battery life and enhancing overall user experience. Alternatively, the network node 110 may use advanced machine learning algorithms to adapt configurations in real-time, further reducing overhead and ensuring optimal resource use under varying conditions.

As indicated above, FIG. 4A is provided as an example to illustrate certain aspects of the disclosure. Other examples and variations may differ from what is described in relation to FIG. 4A but are intended to fall within the scope of the disclosed methods and apparatuses for optimizing multi-carrier communication in wireless networks. For example, some aspects may include different forms of signaling for capability information, such as periodic reporting or triggered updates based on specific events (e.g., changes in UE 120 location or network conditions). Additionally, some aspects may involve advanced interference management techniques that allow better coexistence of multiple UEs in crowded network scenarios.

FIG. 4B depicts an example 420 in which a UE 120 may be configured to communicate using sTB scheduling when the UE 120 is operating in a multi-carrier operation (e.g., CA, FSI, and/or a similar multi-carrier operation). As shown in FIG. 4B, a multi-carrier operation may be associated with multiple bands, including a first band 425 (shown in FIG. 4B as “B1”) and a second band 430 (shown in FIG. 4B as “B2”). The first band 425 may be associated with multiple SBs 435 or CCs, such as a first SB 435-1 (indexed as SB0 in FIG. 4B) and a second SB 435-2 (indexed as SB1 in FIG. 4B). Similarly, the second band 430 may be associated with multiple SBs 440 or CCs, including a third SB 440-1 (indexed as SB2 in FIG. 4B) and a fourth SB 440-2 (indexed as SB3 in FIG. 4B).

In some aspects, a UE 120 may signal (e.g., via the capability information described above in connection with reference number 405) certain capability information regarding the multi-carrier operation and/or sTB scheduling while operating in the multi-carrier operation. For example, the UE 120 may indicate that the UE 120 supports multi-carrier operation (e.g., CA and/or FSI) in B1-B2 with two CCs of bandwidth X MHz in B1 and two CCs of bandwidth Y MHz in B2. The UE 120 may further indicate that the UE 120 supports sTB scheduling in B1-B2 using one CC and/or SB of less than or equal to X_1 MHz in B1 one CC and/or SB of less than or equal to Y_1 MHz in B2. The UE 120 may report additional capabilities and/or conditions as described above in connection with FIG. 4A, such as maximum modulation order and/or MCS supported for sTB scheduling (e.g., per CC and/or SB or across CCs and/or SBs), maximum rank supported for sTB scheduling (e.g., per CC and/or SB or across CCs and/or SBs), and/or similar conditions.

In such aspects, because the bandwidth of the configured SB0 (e.g., the first SB 435-1) and SB2 (e.g., the third SB 440-1) satisfy the UE 120's reported conditions, the UE 120 may be configured to support sTB scheduling across SB0 and SB1. Put another way, because SB0 and SB1 meet the conditions, indicated by the UE 120 in the capability information, for sTB scheduling when the UE 120 is operating in the multi-carrier operation, one TB may be mapped to resources in both SBs (e.g., both SB0 and SB2) and/or one TB may be transmitted repeatedly across these SBs, subject to any modulation order, MCS, and/or rank restrictions signaled by the UE 120.

In such aspects, the sTB scheduling semi-static configuration may be aligned to the UE 120's reported capabilities. In some other aspects, however, such semi-static configurations may not be desirable. For example, a UE 120 may support a virtual cell having 20 MHz in FDD and 100 MHz in TDD, but the UE 120 may be capable of supporting sTB scheduling across 20 MHz of FDD and only 20 MHz of TDD. In such aspects, it may be desirable to not limit the bandwidth of the virtual cell but rather to only limit the operational bandwidth for sTB scheduling. In such aspects, any conditions reported by the UE 120 (e.g., via the capability information described above in connection with reference number 405) may be satisfied by scheduling a grant-based DL or UL communication. Put another way, in some aspects, when an sTB scheduling is expected, the grant (e.g., the scheduling communication described above in connection with reference number 415) may be consistent with the reported UE 120 capabilities. For grant-free DL and/or UL communications, such as semi-persistent scheduling (SPS) communications and/or configured grant PUSCH (CG-PUSCH) communications, the restrictions on sTB-based transmissions may be made independent of the configuration of the multi-carrier operation (e.g., CA and/or FSI), with the configuration of the grant-free DL and/or UL communications (e.g., the configuration of the SPS communications and/or the CG-PUSCH communications) being aligned with the UE 120's reported capabilities and associated restrictions.

More particularly, FIG. 4C depicts an example 445 in which a UE 120 may be scheduled to communicate using an sTB-based transmission when the UE 120 is operating in a multi-carrier operation (e.g., CA, FSI, and/or a similar multi-carrier operation). As described above in connection with FIG. 4B, the multi-carrier operation in FIG. 4C may be associated with multiple bands, including the first band 425 (e.g., B1) associated with multiple SBs 435 (e.g., the first SB 435-1 and the second SB 435-2) and the second band 430 (e.g., B2) associated with multiple SBs 440 (e.g., the third SB 440-1 and the fourth SB 440-2). In this aspect, the UE 120 may signal (e.g., via the capability information described above in connection with reference number 405) that the UE 120 supports multi-carrier operation (e.g., CA and/or FSI) in B1-B2 with two CCs and/or SBs that collectively form X MHz in B1 and with two CCs and/or SBs that collectively form Y MHz in B2. The UE 120 may further indicate that the UE 120 supports sTB scheduling in B1-B2 using one CC and/or SB of less than or equal to X_2 MHz in B1 (where X_2<X_1) and one CC and/or SB of less than or equal to Y_2 MHz in B2 (where Y_2<Y_1). Again, the UE 120 may report additional capabilities and/or conditions as described above in connection with FIG. 4A, such as maximum modulation order and/or MCS supported for sTB scheduling (e.g., per CC and/or SB or across CCs and/or SBs), maximum rank supported for sTB scheduling (e.g., per CC and/or SB or across CCs and/or SBs), and/or similar conditions.

In this aspect, the UE 120 may receive a scheduling communication 450 (e.g., a PDCCH communication, which may correspond to the scheduling communication described above in connection with reference number 415) that schedules an sTB-based communication that aligns with the UE 120's reported capabilities. For example, as indicated by reference number 465, the scheduling communication may schedule the sTB-based transmission using a first portion 455 of the first SB 435-1 and using a second portion 460 of the third SB 440-1. In such aspects, the bandwidth associated with the first portion 455 and the second portion 460 may be less than X_1 and Y_1, respectively, so as to meet the conditions indicated by the UE capability information. More particularly, the bandwidth associated with the first portion 455 and the second portion 460 may be less than or equal to X_2 and Y_2, respectively.

In aspects in which the scheduling communication 450 schedules a communication for which the conditions indicated by the UE 120 are not met (e.g., a scheduling communication that is associated with a bandwidth of greater than X_2 in SB0 and/or that is associated with a bandwidth of greater than Y_2 in SB2), only multi-TB scheduling may be supported by the UE 120 and/or scheduling of only a single TB using a single CC and/or SB may be supported by the UE 120 (e.g., sTB scheduling using a multi-carrier operation may not be possible). Otherwise, if the scheduling communication 450 indicates that an sTB-based transmission is to be scheduled that does not meet the UE 120 capabilities, the scheduling communication 450 may be interpreted by the UE 120 as an error event. Moreover, although the example 445 is described in terms of maximum bandwidth at each CC and/or SB for an sTB-based transmission, any other reported conditions (e.g., any of the conditions described above in connection with reference number 405) may be treated in a similar manner (e.g., any reported conditions in the capability information may be expected to be respected as part of the scheduling communication 450).

Based at least in part on the network node 110 configuring the UE 120 with information in accordance with the UE 120 sTB scheduling capabilities or transmitting, to the UE 120, a scheduling communication in accordance with the UE 120 sTB scheduling capabilities, the UE 120 and/or the network node 110 may conserve computing, power, network, and/or communication resources that may have otherwise been consumed by the network node 110 performing sTB scheduling agnostic to the UE 120 capabilities. For example, based at least in part on the network node 110 configuring the UE 120 with information in accordance with the UE 120 sTB scheduling capabilities or transmitting, to the UE 120, a scheduling communication in accordance with the UE 120 sTB scheduling capabilities, the UE 120 and the network node 110 may communicate with a reduced error rate, which may conserve computing, power, network, and/or communication resources that may have otherwise been consumed to detect and/or correct communication errors.

As indicated above, FIGS. 4A-4C are provided as an example. Other examples may differ from what is described with respect to FIGS. 4A-4C.

FIG. 5 is a diagram illustrating an example process 500 performed, for example, at a UE or an apparatus of a UE, in accordance with the present disclosure. Example process 500 is an example where the apparatus or the UE (e.g., UE 120) performs operations associated with sTB scheduling for a UE operating in a multi-carrier operation.

As shown in FIG. 5, in some aspects, process 500 may include transmitting capability information indicating: UE support for sTB scheduling when the UE is operating in a multi-carrier operation, and one or more conditions associated with the sTB scheduling when the UE is operating in the multi-carrier operation (block 510). For example, the UE (e.g., using transmission component 704 and/or communication manager 706, depicted in FIG. 7) may transmit capability information indicating: UE support for sTB scheduling when the UE is operating in a multi-carrier operation, and one or more conditions associated with the sTB scheduling when the UE is operating in the multi-carrier operation, as described above.

As further shown in FIG. 5, in some aspects, process 500 may include receiving, based at least in part on the capability information, at least one of: configuration information associated with the sTB scheduling when the UE is operating in the multi-carrier operation, or a scheduling communication that schedules an sTB-based transmission when the UE is operating in the multi-carrier operation (block 520). For example, the UE (e.g., using reception component 702 and/or communication manager 706, depicted in FIG. 7) may receive, based at least in part on the capability information, at least one of: configuration information associated with the sTB scheduling when the UE is operating in the multi-carrier operation, or a scheduling communication that schedules an sTB-based transmission when the UE is operating in the multi-carrier operation, as described above.

Process 500 may include additional aspects, such as any single aspect or any combination of aspects described below and/or in connection with one or more other processes described elsewhere herein.

In a first aspect, the at least one of the configuration information or the scheduling communication is based at least in part on at least one of whether the multi-carrier operation is associated with a combination of one or more frequency-division duplex bands or one or more time-division duplex bands that is permitted to be used for sTB scheduling by a wireless communication standard, whether the multi-carrier operation is associated with one or more duplexing modes that are permitted to be used for sTB scheduling by the wireless communication standard, whether the multi-carrier operation is associated with one or more frequency ranges that are permitted to be used for sTB scheduling by the wireless communication standard, whether the sTB-based transmission is associated with one of an uplink transmission or a downlink transmission that is permitted to be used for sTB scheduling by the wireless communication standard, or whether a difference between a first bandwidth associated with a first carrier of the multi-carrier operation and a second bandwidth associated with a second carrier of the multi-carrier operation is less than a bandwidth-difference threshold.

In a second aspect, alone or in combination with the first aspect, transmitting the capability information includes signaling the capability information integral with other capability information used to indicate UE support for the multi-carrier operation.

In a third aspect, alone or in combination with one or more of the first and second aspects, signaling the capability information integral with the other capability information includes indicating support for sTB scheduling on at least one of a feature set per component carrier basis, a feature set basis, or a frequency band basis.

In a fourth aspect, alone or in combination with one or more of the first through third aspects, transmitting the capability information includes signaling the capability information separate from other capability information used to indicate UE support for the multi-carrier operation.

In a fifth aspect, alone or in combination with one or more of the first through fourth aspects, the one or more conditions associated with the sTB scheduling include a maximum bandwidth associated with the sTB scheduling.

In a sixth aspect, alone or in combination with one or more of the first through fifth aspects, the one or more conditions associated with the sTB scheduling include at least one of a bandwidth-difference threshold associated with the sTB scheduling or a maximum bandwidth associated with the sTB scheduling on at least one of a CC basis, a SB basis, at least one of a CC per band basis or an SB per band basis, or a band in a band combination basis.

In a seventh aspect, alone or in combination with one or more of the first through sixth aspects, the one or more conditions associated with the sTB scheduling include at least one of a maximum number of component carriers associated with the sTB scheduling, or a maximum number of sub-bands associated with the sTB scheduling.

In an eighth aspect, alone or in combination with one or more of the first through seventh aspects, the one or more conditions associated with the sTB scheduling include a maximum quantity of layers associated with the sTB scheduling.

In a ninth aspect, alone or in combination with one or more of the first through eighth aspects, the one or more conditions associated with the sTB scheduling include a maximum modulation and coding scheme associated with the sTB scheduling.

In a tenth aspect, alone or in combination with one or more of the first through ninth aspects, the one or more conditions associated with the sTB scheduling include at least one of a minimum downlink processing timeline associated with the sTB scheduling, or a minimum uplink processing timeline associated with the sTB scheduling.

In an eleventh aspect, alone or in combination with one or more of the first through tenth aspects, the one or more conditions associated with the sTB scheduling include at least one of a minimum CSI processing timeline associated with the sTB scheduling, a maximum quantity of CSI processes associated with the sTB scheduling, a maximum quantity of transport blocks per slot associated with the sTB scheduling, a maximum quantity of control channels per slot associated with the sTB scheduling, or a maximum quantity of at least one of control channel elements or blind decodes associated with the sTB scheduling.

In a twelfth aspect, alone or in combination with one or more of the first through eleventh aspects, receiving the at least one of the configuration information or the scheduling communication includes receiving the scheduling communication, wherein the scheduling communication indicates one or more communication parameters associated with the sTB-based transmission, and wherein the one or more communication parameters are based at least in part on the one or more conditions associated with the sTB scheduling.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with sTB scheduling for a UE operating in a multi-carrier operation.

As shown in FIG. 6, in some aspects, process 600 may include receiving, from a UE, capability information indicating: UE support for sTB scheduling when the UE is operating in a multi-carrier operation, and one or more conditions associated with the sTB scheduling when the UE is operating in the multi-carrier operation (block 610). For example, the network node (e.g., using reception component 802 and/or communication manager 806, depicted in FIG. 8) may receive, from a UE, capability information indicating: UE support for sTB scheduling when the UE is operating in a multi-carrier operation, and one or more conditions associated with the sTB scheduling when the UE is operating in the multi-carrier operation, as described above.

As further shown in FIG. 6, in some aspects, process 600 may include transmitting, to the UE and based at least in part on the capability information, at least one of: configuration information associated with the sTB scheduling when the UE is operating in the multi-carrier operation, or a scheduling communication that schedules an sTB-based transmission when the UE is operating in the multi-carrier operation (block 620). For example, the network node (e.g., using transmission component 804 and/or communication manager 806, depicted in FIG. 8) may transmit, to the UE and based at least in part on the capability information, at least one of: configuration information associated with the sTB scheduling when the UE is operating in the multi-carrier operation, or a scheduling communication that schedules an sTB-based transmission when the UE is operating in the multi-carrier operation, as described above.

Process 600 may include additional aspects, such as any single aspect or any combination of aspects described below and/or in connection with one or more other processes described elsewhere herein.

In a first aspect, the at least one of the configuration information or the scheduling communication is based at least in part on at least one of whether the multi-carrier operation is associated with a combination of one or more frequency-division duplex bands or one or more time-division duplex bands that is permitted to be used for sTB scheduling by a wireless communication standard, whether the multi-carrier operation is associated with one or more duplexing modes that are permitted to be used for sTB scheduling by the wireless communication standard, whether the multi-carrier operation is associated with one or more frequency ranges that are permitted to be used for sTB scheduling by the wireless communication standard, whether the sTB-based transmission is associated with one of an uplink transmission or a downlink transmission that is permitted to be used for sTB scheduling by the wireless communication standard, or whether a difference between a first bandwidth associated with a first carrier of the multi-carrier operation and a second bandwidth associated with a second carrier of the multi-carrier operation is less than a bandwidth-difference threshold.

In a second aspect, alone or in combination with the first aspect, receiving the capability information includes receiving the capability information integral with other capability information used to indicate UE support for the multi-carrier operation.

In a third aspect, alone or in combination with one or more of the first and second aspects, receiving the capability information integral with the other capability information includes receiving an indication of support for sTB scheduling on at least one of a feature set per component carrier basis, a feature set basis, or a frequency band basis.

In a fourth aspect, alone or in combination with one or more of the first through third aspects, receiving the capability information includes receiving the capability information separate from other capability information used to indicate UE support for the multi-carrier operation.

In a fifth aspect, alone or in combination with one or more of the first through fourth aspects, the one or more conditions associated with the sTB scheduling include a maximum bandwidth associated with the sTB scheduling.

In a sixth aspect, alone or in combination with one or more of the first through fifth aspects, the one or more conditions associated with the sTB scheduling include at least one of a bandwidth-difference threshold associated with the sTB scheduling or a maximum bandwidth associated with the sTB scheduling on at least one of a CC basis, a SB basis, at least one of a CC per band basis or an SB per band basis, or a band in a band combination basis.

In a seventh aspect, alone or in combination with one or more of the first through sixth aspects, the one or more conditions associated with the sTB scheduling include at least one of a maximum number of component carriers associated with the sTB scheduling, or a maximum number of sub-bands associated with the sTB scheduling.

In an eighth aspect, alone or in combination with one or more of the first through seventh aspects, the one or more conditions associated with the sTB scheduling include a maximum quantity of layers associated with the sTB scheduling.

In a ninth aspect, alone or in combination with one or more of the first through eighth aspects, the one or more conditions associated with the sTB scheduling include a maximum modulation and coding scheme associated with the sTB scheduling.

In a tenth aspect, alone or in combination with one or more of the first through ninth aspects, the one or more conditions associated with the sTB scheduling include at least one of a minimum downlink processing timeline associated with the sTB scheduling, or a minimum uplink processing timeline associated with the sTB scheduling.

In an eleventh aspect, alone or in combination with one or more of the first through tenth aspects, the one or more conditions associated with the sTB scheduling include at least one of a minimum CSI processing timeline associated with the sTB scheduling, a maximum quantity of CSI processes associated with the sTB scheduling, a maximum quantity of transport blocks per slot associated with the sTB scheduling, a maximum quantity of control channels per slot associated with the sTB scheduling, or a maximum quantity of at least one of control channel elements or blind decodes associated with the sTB scheduling.

In a twelfth aspect, alone or in combination with one or more of the first through eleventh aspects, transmitting the at least one of the configuration information or the scheduling communication includes transmitting the scheduling communication, wherein the scheduling communication indicates one or more communication parameters associated with the sTB-based transmission, and process 600 includes selecting the one or more communication parameters based at least in part on the one or more conditions associated with the sTB scheduling.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 4A-4C. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE 120 described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE 120 described above in connection with FIG. 1, such as a radio, one or more RF chains, one or more transceivers, or one or more modems, each of which may in turn be coupled with one or more antennas of the UE 120.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The transmission component 704 may transmit capability information indicating UE support for sTB scheduling when the UE is operating in a multi-carrier operation, and one or more conditions associated with the sTB scheduling when the UE is operating in the multi-carrier operation. The reception component 702 may receive, based at least in part on the capability information, at least one of configuration information associated with the sTB scheduling when the UE is operating in the multi-carrier operation, or a scheduling communication that schedules an sTB-based transmission when the UE is operating in the multi-carrier operation.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 4A-4C. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node 110 described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node 110 described above in connection with FIG. 1, such as a radio, one or more RF chains, one or more transceivers, or one or more modems, each of which may in turn be coupled with one or more antennas of the network node 110. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, from a UE, capability information indicating UE support for sTB scheduling when the UE is operating in a multi-carrier operation, and one or more conditions associated with the sTB scheduling when the UE is operating in the multi-carrier operation. The transmission component 804 may transmit, to the UE and based at least in part on the capability information, at least one of configuration information associated with the sTB scheduling when the UE is operating in the multi-carrier operation, or a scheduling communication that schedules an sTB-based transmission when the UE is operating in the multi-carrier operation.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: transmitting capability information indicating: UE support for single transport block (sTB) scheduling when the UE is operating in a multi-carrier operation, and one or more conditions associated with the sTB scheduling when the UE is operating in the multi-carrier operation; and receiving, based at least in part on the capability information, at least one of: configuration information associated with the sTB scheduling when the UE is operating in the multi-carrier operation, or a scheduling communication that schedules an sTB-based transmission when the UE is operating in the multi-carrier operation.

Aspect 2: The method of Aspect 1, wherein the at least one of the configuration information or the scheduling communication is based at least in part on at least one of: whether the multi-carrier operation is associated with a combination of one or more frequency-division duplex bands or one or more time-division duplex bands that is permitted to be used for sTB scheduling by a wireless communication standard, whether the multi-carrier operation is associated with one or more duplexing modes that are permitted to be used for sTB scheduling by the wireless communication standard, whether the multi-carrier operation is associated with one or more frequency ranges that are permitted to be used for sTB scheduling by the wireless communication standard, whether the sTB-based transmission is associated with one of an uplink transmission or a downlink transmission that is permitted to be used for sTB scheduling by the wireless communication standard, or whether a difference between a first bandwidth associated with a first carrier of the multi-carrier operation and a second bandwidth associated with a second carrier of the multi-carrier operation is less than a bandwidth-difference threshold.

Aspect 3: The method of any of Aspects 1-2, wherein transmitting the capability information includes signaling the capability information integral with other capability information used to indicate UE support for the multi-carrier operation.

Aspect 4: The method of Aspect 3, wherein signaling the capability information integral with the other capability information includes indicating support for sTB scheduling on at least one of: a feature set per component carrier basis, a feature set basis, or a frequency band basis.

Aspect 5: The method of any of Aspects 1-2, wherein transmitting the capability information includes signaling the capability information separate from other capability information used to indicate UE support for the multi-carrier operation.

Aspect 6: The method of any of Aspects 1-5, wherein the one or more conditions associated with the sTB scheduling include a maximum bandwidth associated with the sTB scheduling.

Aspect 7: The method of any of Aspects 1-6, wherein the one or more conditions associated with the sTB scheduling include at least one of a bandwidth-difference threshold associated with the sTB scheduling or a maximum bandwidth associated with the sTB scheduling on at least one of: a component carrier (CC) basis, a sub-band (SB) basis, at least one of a CC per band basis or an SB per band basis, or a band in a band combination basis.

Aspect 8: The method of any of Aspects 1-7, wherein the one or more conditions associated with the sTB scheduling include at least one of: a maximum number of component carriers associated with the sTB scheduling, or a maximum number of sub-bands associated with the sTB scheduling.

Aspect 9: The method of any of Aspects 1-8, wherein the one or more conditions associated with the sTB scheduling include a maximum quantity of layers associated with the sTB scheduling.

Aspect 10: The method of any of Aspects 1-9, wherein the one or more conditions associated with the sTB scheduling include a maximum modulation and coding scheme associated with the sTB scheduling.

Aspect 11: The method of any of Aspects 1-10, wherein the one or more conditions associated with the sTB scheduling include at least one of: a minimum downlink processing timeline associated with the sTB scheduling, or a minimum uplink processing timeline associated with the sTB scheduling.

Aspect 12: The method of any of Aspects 1-11, wherein the one or more conditions associated with the sTB scheduling include at least one of: a minimum channel state information (CSI) processing timeline associated with the sTB scheduling, a maximum quantity of CSI processes associated with the sTB scheduling, a maximum quantity of transport blocks per slot associated with the sTB scheduling, a maximum quantity of control channels per slot associated with the sTB scheduling, or a maximum quantity of at least one of control channel elements or blind decodes associated with the sTB scheduling.

Aspect 13: The method of any of Aspects 1-12, wherein receiving the at least one of the configuration information or the scheduling communication includes receiving the scheduling communication, wherein the scheduling communication indicates one or more communication parameters associated with the sTB-based transmission, and wherein the one or more communication parameters are based at least in part on the one or more conditions associated with the sTB scheduling.

Aspect 14: A method of wireless communication performed by a network node, comprising: receiving, from a user equipment (UE), capability information indicating: UE support for single transport block (sTB) scheduling when the UE is operating in a multi-carrier operation, and one or more conditions associated with the sTB scheduling when the UE is operating in the multi-carrier operation; and transmitting, to the UE and based at least in part on the capability information, at least one of: configuration information associated with the sTB scheduling when the UE is operating in the multi-carrier operation, or a scheduling communication that schedules an sTB-based transmission when the UE is operating in the multi-carrier operation.

Aspect 15: The method of Aspect 14, wherein the at least one of the configuration information or the scheduling communication is based at least in part on at least one of: whether the multi-carrier operation is associated with a combination of one or more frequency-division duplex bands or one or more time-division duplex bands that is permitted to be used for sTB scheduling by a wireless communication standard, whether the multi-carrier operation is associated with one or more duplexing modes that are permitted to be used for sTB scheduling by the wireless communication standard, whether the multi-carrier operation is associated with one or more frequency ranges that are permitted to be used for sTB scheduling by the wireless communication standard, whether the sTB-based transmission is associated with one of an uplink transmission or a downlink transmission that is permitted to be used for sTB scheduling by the wireless communication standard, or whether a difference between a first bandwidth associated with a first carrier of the multi-carrier operation and a second bandwidth associated with a second carrier of the multi-carrier operation is less than a bandwidth-difference threshold.

Aspect 16: The method of any of Aspects 14-15, wherein receiving the capability information includes receiving the capability information integral with other capability information used to indicate UE support for the multi-carrier operation.

Aspect 17: The method of Aspect 16, wherein receiving the capability information integral with the other capability information includes receiving an indication of support for sTB scheduling on at least one of: a feature set per component carrier basis, a feature set basis, or a frequency band basis.

Aspect 18: The method of any of Aspects 14-15, wherein receiving the capability information includes receiving the capability information separate from other capability information used to indicate UE support for the multi-carrier operation.

Aspect 19: The method of any of Aspects 14-18, wherein the one or more conditions associated with the sTB scheduling include a maximum bandwidth associated with the sTB scheduling.

Aspect 20: The method of any of Aspects 14-19, wherein the one or more conditions associated with the sTB scheduling include at least one of a bandwidth-difference threshold associated with the sTB scheduling or a maximum bandwidth associated with the sTB scheduling on at least one of: a component carrier (CC) basis, a sub-band (SB) basis, at least one of a CC per band basis or an SB per band basis, or a band in a band combination basis.

Aspect 21: The method of any of Aspects 14-20, wherein the one or more conditions associated with the sTB scheduling include at least one of: a maximum number of component carriers associated with the sTB scheduling, or a maximum number of sub-bands associated with the sTB scheduling.

Aspect 22: The method of any of Aspects 14-21, wherein the one or more conditions associated with the sTB scheduling include a maximum quantity of layers associated with the sTB scheduling.

Aspect 23: The method of any of Aspects 14-22, wherein the one or more conditions associated with the sTB scheduling include a maximum modulation and coding scheme associated with the sTB scheduling.

Aspect 24: The method of any of Aspects 14-23, wherein the one or more conditions associated with the sTB scheduling include at least one of: a minimum downlink processing timeline associated with the sTB scheduling, or a minimum uplink processing timeline associated with the sTB scheduling.

Aspect 25: The method of any of Aspects 14-24, wherein the one or more conditions associated with the sTB scheduling include at least one of: a minimum channel state information (CSI) processing timeline associated with the sTB scheduling, a maximum quantity of CSI processes associated with the sTB scheduling, a maximum quantity of transport blocks per slot associated with the sTB scheduling, a maximum quantity of control channels per slot associated with the sTB scheduling, or a maximum quantity of at least one of control channel elements or blind decodes associated with the sTB scheduling.

Aspect 26: The method of any of Aspects 14-25, wherein transmitting the at least one of the configuration information or the scheduling communication includes transmitting the scheduling communication, wherein the scheduling communication indicates one or more communication parameters associated with the sTB-based transmission, and wherein the method further comprises selecting the one or more communication parameters based at least in part on the one or more conditions associated with the sTB scheduling.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.
Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, which are configured, individually or in any combination, to:
transmit capability information indicating:
UE support for single transport block (sTB) scheduling when the UE is operating in a multi-carrier operation, and
one or more conditions associated with the sTB scheduling when the UE is operating in the multi-carrier operation; and
receive, based at least in part on the capability information, at least one of:
configuration information associated with the sTB scheduling when the UE is operating in the multi-carrier operation, or
a scheduling communication that schedules an sTB-based transmission when the UE is operating in the multi-carrier operation.

2. The UE of claim 1, wherein the at least one of the configuration information or the scheduling communication is based at least in part on at least one of:
whether the multi-carrier operation is associated with a combination of one or more frequency-division duplex bands or one or more time-division duplex bands that is permitted to be used for sTB scheduling by a wireless communication standard,
whether the multi-carrier operation is associated with one or more duplexing modes that are permitted to be used for sTB scheduling by the wireless communication standard,
whether the multi-carrier operation is associated with one or more frequency ranges that are permitted to be used for sTB scheduling by the wireless communication standard,
whether the sTB-based transmission is associated with one of an uplink transmission or a downlink transmission that is permitted to be used for sTB scheduling by the wireless communication standard, or
whether a difference between a first bandwidth associated with a first carrier of the multi-carrier operation and a second bandwidth associated with a second carrier of the multi-carrier operation is less than a bandwidth-difference threshold.

3. The UE of claim 1, wherein the one or more processors, to transmit the capability information, are configured, individually or in any combination, to signal the capability information integral with other capability information used to indicate UE support for the multi-carrier operation.

4. The UE of claim 3, wherein the one or more processors, to signal the capability information integral with the other capability information, are configured, individually or in any combination, to indicate support for sTB scheduling on at least one of:
a feature set per component carrier basis,
a feature set basis, or
a frequency band basis.

5. The UE of claim 1, wherein the one or more processors, to transmit the capability information, are configured, individually or in any combination, to signal the capability information separate from other capability information used to indicate UE support for the multi-carrier operation.

6. The UE of claim 1, wherein the one or more conditions associated with the sTB scheduling include a maximum bandwidth associated with the sTB scheduling.

7. The UE of claim 1, wherein the one or more conditions associated with the sTB scheduling include at least one of a bandwidth-difference threshold associated with the sTB scheduling or a maximum bandwidth associated with the sTB scheduling on at least one of:
a component carrier (CC) basis,
a sub-band (SB) basis,
at least one of a CC per band basis or an SB per band basis, or
a band in a band combination basis.

8. The UE of claim 1, wherein the one or more conditions associated with the sTB scheduling include at least one of:
a maximum number of component carriers associated with the sTB scheduling, or
a maximum number of sub-bands associated with the sTB scheduling.

9. The UE of claim 1, wherein the one or more conditions associated with the sTB scheduling include a maximum quantity of layers associated with the sTB scheduling.

10. The UE of claim 1, wherein the one or more conditions associated with the sTB scheduling include a maximum modulation and coding scheme associated with the sTB scheduling.

11. The UE of claim 1, wherein the one or more conditions associated with the sTB scheduling include at least one of:
a minimum downlink processing timeline associated with the sTB scheduling, or
a minimum uplink processing timeline associated with the sTB scheduling.

12. The UE of claim 1, wherein the one or more conditions associated with the sTB scheduling include at least one of:
a minimum channel state information (CSI) processing timeline associated with the sTB scheduling,
a maximum quantity of CSI processes associated with the sTB scheduling,
a maximum quantity of transport blocks per slot associated with the sTB scheduling,
a maximum quantity of control channels per slot associated with the sTB scheduling, or
a maximum quantity of at least one of control channel elements or blind decodes associated with the sTB scheduling.

13. The UE of claim 1, wherein the one or more processors, to receive the at least one of the configuration information or the scheduling communication, are configured, individually or in any combination, to receive the scheduling communication,
wherein the scheduling communication indicates one or more communication parameters associated with the sTB-based transmission, and
wherein the one or more communication parameters are based at least in part on the one or more conditions associated with the sTB scheduling.

14. A network node for wireless communication, comprising:
one or more memories; and
one or more processors, coupled to the one or more memories, which are configured, individually or in any combination, to:
receive, from a user equipment (UE), capability information indicating:
UE support for single transport block (sTB) scheduling when the UE is operating in a multi-carrier operation, and
one or more conditions associated with the sTB scheduling when the UE is operating in the multi-carrier operation; and
transmit, to the UE and based at least in part on the capability information, at least one of:
configuration information associated with the sTB scheduling when the UE is operating in the multi-carrier operation, or
a scheduling communication that schedules an sTB-based transmission when the UE is operating in the multi-carrier operation.

15. The network node of claim 14, wherein the at least one of the configuration information or the scheduling communication is based at least in part on at least one of:
whether the multi-carrier operation is associated with a combination of one or more frequency-division duplex bands or one or more time-division duplex bands that is permitted to be used for sTB scheduling by a wireless communication standard,
whether the multi-carrier operation is associated with one or more duplexing modes that are permitted to be used for sTB scheduling by the wireless communication standard,
whether the multi-carrier operation is associated with one or more frequency ranges that are permitted to be used for sTB scheduling by the wireless communication standard,
whether the sTB-based transmission is associated with one of an uplink transmission or a downlink transmission that is permitted to be used for sTB scheduling by the wireless communication standard, or
whether a difference between a first bandwidth associated with a first carrier of the multi-carrier operation and a second bandwidth associated with a second carrier of the multi-carrier operation is less than a bandwidth-difference threshold.

16. The network node of claim 14, wherein the one or more processors, to receive the capability information, are configured, individually or in any combination, to receive the capability information integral with other capability information used to indicate UE support for the multi-carrier operation.

17. The network node of claim 16, wherein the one or more processors, to receive the capability information integral with the other capability information, are configured, individually or in any combination, to receive an indication of support for sTB scheduling on at least one of:
a feature set per component carrier basis,
a feature set basis, or
a frequency band basis.

18. The network node of claim 14, wherein the one or more processors, to receive the capability information, are configured, individually or in any combination, to receive the capability information separate from other capability information used to indicate UE support for the multi-carrier operation.

19. The network node of claim 14, wherein the one or more conditions associated with the sTB scheduling include a maximum bandwidth associated with the sTB scheduling.

20. The network node of claim 14, wherein the one or more conditions associated with the sTB scheduling include at least one of a bandwidth-difference threshold associated with the sTB scheduling or a maximum bandwidth associated with the sTB scheduling on at least one of:
a component carrier (CC) basis,
a sub-band (SB) basis,
at least one of a CC per band basis or an SB per band basis, or
a band in a band combination basis.

21. The network node of claim 14, wherein the one or more conditions associated with the sTB scheduling include at least one of:
a maximum number of component carriers associated with the sTB scheduling, or
a maximum number of sub-bands associated with the sTB scheduling.

22. The network node of claim 14, wherein the one or more conditions associated with the sTB scheduling include a maximum quantity of layers associated with the sTB scheduling.

23. The network node of claim 14, wherein the one or more conditions associated with the sTB scheduling include a maximum modulation and coding scheme associated with the sTB scheduling.

24. The network node of claim 14, wherein the one or more conditions associated with the sTB scheduling include at least one of:
a minimum downlink processing timeline associated with the sTB scheduling, or
a minimum uplink processing timeline associated with the sTB scheduling.

25. The network node of claim 14, wherein the one or more conditions associated with the sTB scheduling include at least one of:
a minimum channel state information (CSI) processing timeline associated with the sTB scheduling,
a maximum quantity of CSI processes associated with the sTB scheduling,
a maximum quantity of transport blocks per slot associated with the sTB scheduling,
a maximum quantity of control channels per slot associated with the sTB scheduling, or
a maximum quantity of at least one of control channel elements or blind decodes associated with the sTB scheduling.

26. The network node of claim 14, wherein the one or more processors, to transmit the at least one of the configuration information or the scheduling communication, are configured, individually or in any combination, to transmit the scheduling communication,
wherein the scheduling communication indicates one or more communication parameters associated with the sTB-based transmission, and
wherein the one or more processors are further configured, individually or in any combination, to select the one or more communication parameters based at least in part on the one or more conditions associated with the sTB scheduling.

27. A method of wireless communication performed by a user equipment (UE), comprising:
transmitting capability information indicating:
UE support for single transport block (sTB) scheduling when the UE is operating in a multi-carrier operation, and
one or more conditions associated with the sTB scheduling when the UE is operating in the multi-carrier operation; and
receiving, based at least in part on the capability information, at least one of:
configuration information associated with the sTB scheduling when the UE is operating in the multi-carrier operation, or
a scheduling communication that schedules an sTB-based transmission when the UE is operating in the multi-carrier operation.

28. The method of claim 27, wherein the at least one of the configuration information or the scheduling communication is based at least in part on at least one of:
whether the multi-carrier operation is associated with a combination of one or more frequency-division duplex bands or one or more time-division duplex bands that is permitted to be used for sTB scheduling by a wireless communication standard,
whether the multi-carrier operation is associated with one or more duplexing modes that are permitted to be used for sTB scheduling by the wireless communication standard,
whether the multi-carrier operation is associated with one or more frequency ranges that are permitted to be used for sTB scheduling by the wireless communication standard,
whether the sTB-based transmission is associated with one of an uplink transmission or a downlink transmission that is permitted to be used for sTB scheduling by the wireless communication standard, or
whether a difference between a first bandwidth associated with a first carrier of the multi-carrier operation and a second bandwidth associated with a second carrier of the multi-carrier operation is less than a bandwidth-difference threshold.

29. A method of wireless communication performed by a network node, comprising:
receiving, from a user equipment (UE), capability information indicating:
UE support for single transport block (sTB) scheduling when the UE is operating in a multi-carrier operation, and
one or more conditions associated with the sTB scheduling when the UE is operating in the multi-carrier operation; and
transmitting, to the UE and based at least in part on the capability information, at least one of:
configuration information associated with the sTB scheduling when the UE is operating in the multi-carrier operation, or
a scheduling communication that schedules an sTB-based transmission when the UE is operating in the multi-carrier operation.

30. The method of claim 29, wherein receiving the capability information includes receiving the capability information separate from other capability information used to indicate UE support for the multi-carrier operation.
